(19) United States
(12) Patent Application Publication
(10) Pub. No.: US 2003/0019553 A1
(43) Pub. Date: Jan. 30, 2003

(54) Run-flat system for pneumatic tires utilizing air-filled elastic balls

(76) Inventors: Song Moon Yun, Honolulu, HI (US); Song K. Choi, Honolulu, HI (US); Sokam D. Kim, Honolulu, HI (US)

Correspondence Address: Martin E. Hsia, P.O. Box 939, Honolulu, HI, 96808-0939, US

(21) Appl. No.: 10/206,072

(22) Filed: Jul. 26, 2002

Related U.S. Application Data
(60) Provisional application No. 60/308,505, filed on Jul. 27, 2001.

(51) Int. Cl. B60C 17/00; B60C 5/00; B60C 19/12

(52) U.S. Cl. 152/157; 152/317

(57) ABSTRACT

This invention comprises an inner tube, a mesh sack, and a plurality of air-filled elastic balls. The mesh sack, preferably made of rubber, is randomly satiated with the elastic balls, and is placed abutting the tread portion (or radially outward portion) of a conventional pneumatic tire. The inner tube is placed abutting the interior portion (or radially inward portion) of the tire, so that the elastic balls are interposed between the inner tube and the radially outward portion of the interior of the tire. Inflation of the inner tube to a specified pneumatic pressure causes the elastic balls to compress against the radially outward interior portion of the tire and each other. The random placement of the elastic balls creates multiple, three-dimensionally independent layers of “air-pockets.” These air-pockets will minimize the effects of punctures from the tread-portion of the tire as well as the sidewall portions of the tire. The invention can be installed on conventional automobile, truck, off-road vehicle, bicycle and motorcycle tires.

### TECHNICAL FIELD

This invention relates to a retrofittable run-flat tire device that can be installed in conventional tires that can allow a wheeled vehicle to function properly in the event of air pressure loss due to puncture of the tire.

### BACKGROUND ART

In almost every type of wheeled vehicle, flat tires are an inevitable consequence of use. At best, flat tires are a nuisance; at worst, flat tires, especially those caused by catastrophic loss of tire air pressure, can lead to severe damage to persons and property, even death. To mitigate or prevent flat tires, numerous types of run-flat tires or devices that allow a wheeled vehicle to perform in the event of a puncture of the tire tread or sidewalls have been developed.

U.S. Pat. No. 488,061 to Bunker et al discloses several variations of an invention where elastic balls or cushions are placed within a tire.

U.S. Pat. No. 492,280 to Fisher et al discloses an invention in which a single line of hollow rubber balls within an inner tube act as a secondary measure of compensation against puncture, and the inner tube is the primary source of air pressure.

U.S. Pat. No. 582,172 to Browne et al discloses a device comprising a series of inflatable bags having valves that allow pressurization from an inner tube to the inflatable bags. Upon puncture of one or more bags, the valves close to prevent air leakage and the remaining adjacent bags close up and take the space of the punctured bag.

U.S. Pat. No. 584,498 to Ettinger et al discloses the use of an outer shoe or armor made of puncture-proof material placed within the tire and inflatable balls fixed in a cushion located along the interior of the of a tire.

U.S. Pat. No. 644,576 by Brady et al discloses an invention comprising a tire partitioned into inflatable and non-inflatable portions, with a single row of spheres loosely placed within the non-inflatable portion of the tire.

U.S. Pat. No. 963,320 to Peck et al discloses a device utilizing a tire having two sections, where balls are located within one section and are fixed in position.

U.S. Pat. No. 1,396,170 to Emeno et al also discloses a device similar to U.S. Pat. No. 644,576 to Brady et al, where rubber balls are fixed in position by a formed external piece located within a pneumatic tire.

U.S. Pat. No. 4,945,965 to Kim et al discloses a run-flat device for pneumatic tires comprising an orderly arrangement of small balloons along the underside of the tread portion of a tire casing as the pary resistance to punctures and an inner tube to provide secondary resistance to punctures.

U.S. Pat. No. 5,894,874 to Yamagiwa et al discloses the use of elastic members that may be placed within bags, which in turn are placed within a tire tube or tubeless tire to allow continued operation of a vehicle after puncture of the tire tube or tubeless tire.

French Patent No. 915,447 to de Dampierre et al discloses a device that utilizes oblong shaped members located within a tire.

Instead of purchasing specialized run-flat tire devices, it is convenient and cost-effective for a consumer if a conventional tire can be retrofitted with a run-flat device. Also, conventional run-flat tires generally require the wheel and tire to be fully supported by a rigid (generally steel) sidings, which may in turn damage the wheels during prolonged use. Furthermore, prolonged use of conventional run-flat tires after puncture usually leads to destruction of the tire and the wheel. Therefore, most run-flat tires must be replaced at relatively great cost.

### DISCLOSURE OF THE INVENTION

Generally, the device comprises a plurality of air-filled elastic balls contained within a mesh sack interposed between an inner tube and the radially outward interior portion of a conventional tire. Compression of the elastic balls by inflation of the inner tube creates a multitude of randomly placed, air-pressurized, independent elastic air chambers that are randomly placed and will act and react independently of each other, so that puncturing of one or a few air chambers will still allow the tire to function.

More specifically, the present invention comprises a toroidal pneumatic inner tube, a mesh sack, and a plurality of elastic balls. The elastic balls are preferably pressurized with air. The mesh sack is preferably made of rubber. In use, the mesh sack is filled with the elastic balls, and is placed inside a conventional pneumatic tire abutting the tread portion (or radially outward portion). The inner tube is placed inside the tire abutting the interior portion (or radially inward portion), so that the elastic balls are interposed between the inner tube and the tread portion of the interior of the tire. Inflation of the inner tube to a specified pneumatic pressure causes the elastic balls to compress against the tread portion of the tire and each other. The random placement of the elastic balls creates multiple three-dimensionally independent layers of “air-pockets.” These air-pockets will minimize the effects of punctures of the tread portion or the sidewall portions of the tire. Any single puncture of the tire will result in only a slight loss of air pressure from an independent pocket, thus the change in performance and comfort of the tires will be minimal if not negligible. Further, the effects of multiple punctures will similarly be mitigated due to the number of air-pockets.

The present invention can be retrofitted to the conventional tires of wheeled vehicles. Thus the present invention does not require the redesigning of the conventional tire system for a wheeled vehicle—whether a uni-cycle, a bicycle, a tricycle, a motorcycle, an automobile or a truck—because the invention can be place within a conventional tire.

### BRIEF DESCRIPTION OF DRAWINGS

FIG. 1 is a perspective, cut-away view of a conventional tire showing the present invention in use.

FIG. 2a shows a side view of a single air-filled elastic ball.

FIG. 2b shows a front view of a single air-filled elastic ball.

FIG. 3a shows a side view of the mesh sack for the air-filled elastic balls of the present invention.

FIG. 3b shows a front view of the mesh sack for the air-filled elastic balls of the present invention.

FIG. 4a shows a side view of the pneumatic inner tube of the present invention.

FIG. 4b shows a front view of the pneumatic inner tube of the present invention.

FIG. 5a shows a side view of the protective liner of the present invention.

FIG. 5b shows a front view of the protective liner of the present invention.

FIG. 6a shows a side view of the present invention where the unpressurized inner tube and air-filled elastic balls are placed within the mesh sack.

FIG. 6b shows a front view of the present invention where the unpressurized inner tube and air-filled elastic balls are placed within the mesh sack.

FIG. 6c shows a front cutaway view of the present invention where the unpressurized inner tube and air-filled elastic balls are placed within the mesh sack.

FIG. 7a shows a partial side cutaway view of the present invention in an unpressurized configuration in a pneumatic tire.

FIG. 7b shows a partial front cutaway view of the present invention in an unpressurized configuration in a pneumatic tire.

FIG. 8a shows a partial side cutaway view of the present invention in a pressurized configuration in a pneumatic tire.

FIG. 8b shows a partial front cutaway view of the present invention in a pressurized configuration in a pneumatic tire.

FIG. 9a shows a side view of an alternative embodiment of the present invention in which the inner tube is not placed in the mesh sack, so that the inner tube is not shown.

FIG. 9b shows a front view of the embodiment of FIG. 9a.

FIG. 9c shows a front cutaway view of the embodiment of FIG. 9a.

FIG. 10a shows a partial side cutaway view of the present invention separated into its various components in an unpressurized configuration within a pneumatic tire.

FIG. 10b shows a partial front cutaway view of the present invention separated into its various components in an unpressurized configuration within a pneumatic tire.

FIG. 11a shows a partial side cutaway view of the present invention separated into its various components in a pressurized configuration within a pneumatic tire.

FIG. 11b shows a partial front cutaway view of the present invention separated into its various components in a pressurized configuration within a pneumatic tire.

FIG. 12a shows a side view of an alternative embodiment of the present invention which utilizes a two-piece modular wheel.

FIG. 12b shows an exploded front view of the embodiment of FIG. 12a.

### BEST MODES FOR CARRYING OUT INVENTION

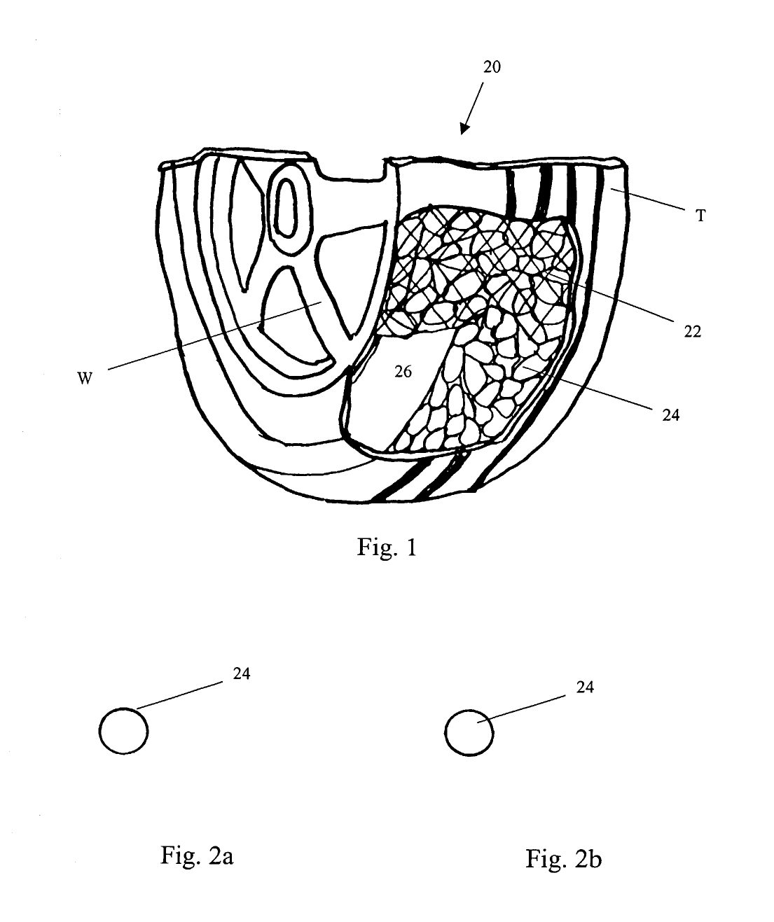

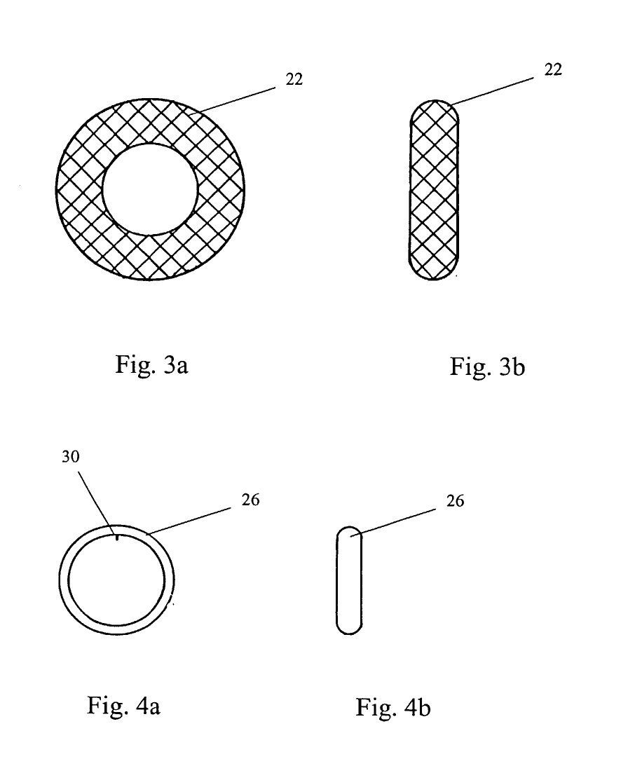

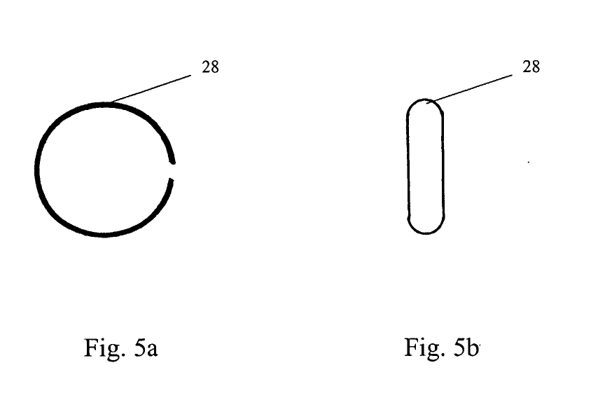

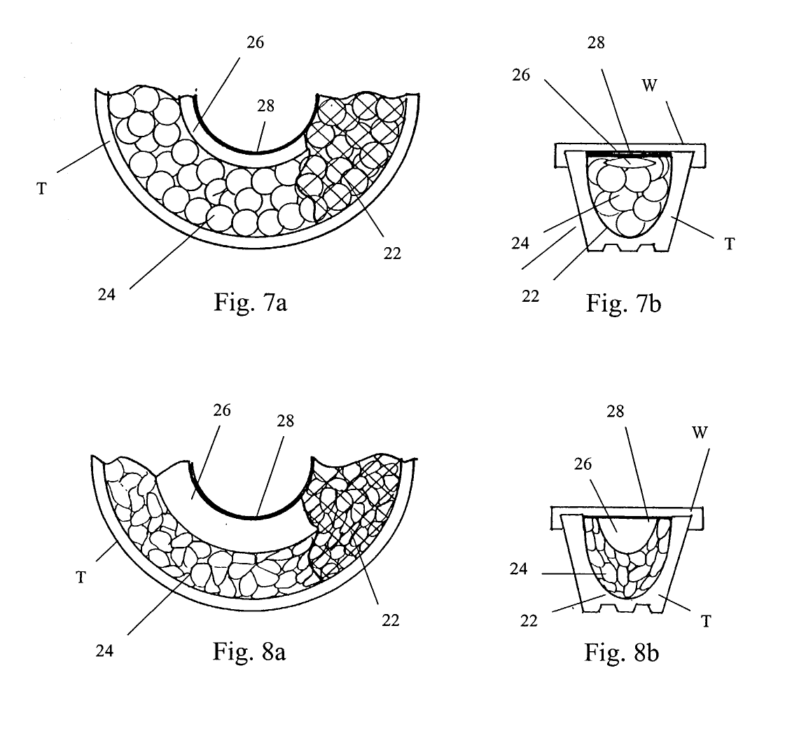

Referring to FIG. 1, a presently preferred embodiment of the present invention 20 installed in a conventional pneumatic tire T and wheel W is shown. The invention 20 preferably comprises a mesh sack 22 randomly satiated with air-filled elastic balls 24, an inner tube 26, and a protective liner 28 (omitted for clarity; see FIGS. 7a, 7b, 8a, and 8b). The mesh sack 22, elastic balls 24 and inner tube 26 are preferably made of elastic rubber. The protective liner 28 is preferably made of a solid, less deformable rubber. The elastic balls 24 are also preferably pressurized with air. As shown, the invention comprises these four components. All four components (the mesh sack, elastic balls, inner tube, and protective liner) are simple and inexpensive to manufacture, which facilitates retrofitting of the invention 20 in conventional tires T. Furthermore, all components of the invention 20 are readily replaceable, without requiring replacement of the entire tire T and/or wheel W. When one or more elastic balls 24 are punctured, more elastic balls 24 may be added. If the mesh sack 22 or inner tube 26 becomes worn or damaged, those components can also be replaced.

First, the invention utilizes hollow elastic balls 24 capable of holding pressurized air. “Balls” refer to spherical containers. In the presently preferred embodiment of the present invention, the elastic balls 24 are capable of elastic deformation under high and low pressures. The pressure requirements for these elastic balls 24 are determined by conventional specifications for pneumatic tires T. Preferably, when fully pressurized, the air pressure within each of the elastic balls 24 will be less than the pressure in the inner tube 26.

Second, the invention utilizes a mesh sack 22, preferably made of rubber, capable of containing a plurality of the elastic balls 24. The mesh sack 22 can be made of varying sizes to accommodate a varied number of elastic balls 24, which number depends on the dimensions of the tire T, including the tire diameter, width and aspect radio. However, preferably, a single size mesh sack 22 should accommodate most conventional vehicle tires T because the mesh sack 22 can expand to accommodate varying numbers of elastic balls 24. The use of a mesh sack 22 is preferred because it reduces the unwanted pneumatic pressures that may arise from trapped air if a conventional closed sack were used. Also, a mesh sack 22 allows greater flexibility of movement for unhindered compression of the elastic balls 24. Finally, the use of a mesh sack 22 reduces the overall weight of the invention 20.

Third, an inner tube 26 preferably formed of rubber is used to properly pressurize the pneumatic tire T. The inner tube 26 will compress the elastic balls 24 against, and cause them to conform to the interior contours of, the pneumatic tire T, any adjacent elastic balls 24 and the inner tube 26. The desired pressures can be determined based on the specifications provided for conventional pneumatic tires T. The pressure in the inner tube 26 is preferably greater than the pressure in each of the elastic balls 24. Current conventional pneumatic tires do not use an inner tube; instead, the tire seals with the wheel to maintain air within the tire. The invention 20 utilizes an inner tube 26 to urge the elastic balls 24 to the radially outward portions of the tire T, specifically the tread portion and the sidewall portions of the tire T, where most punctures occur. Since any puncture will first encounter the elastic balls 24, the location of the elastic balls 24 in the radially outward portions of the tire T provides protection even against multiple punctures since all remaining elastic balls 24 adjacent to any punctured elastic ball will further deform to replace the space once occupied by the now punctured elastic ball. Because the pressure in the inner tube 26 is preferably greater than the pressure in the elastic balls 24, the inner tube 26 will exert a pressure on the elastic balls 24 to urge the elastic balls 24 towards the radially outward portion of the tire T.

Fourth, a preferably thick protective liner 28, preferably formed from solid rubber, is placed between the inner tube 26 and the metal wheel W. The protective liner 28 will not only cover the middle contact areas of the wheel W and inner tube 26 but also protect the sides of the wheel W and any tool used to remove and insert the tire T to the wheel W. In use, the inner tube 26 contacts only the protective liner 28. The pressure exerted by the inner tube 26 and elastic balls 24 is evenly distributed on the protective liner 28.

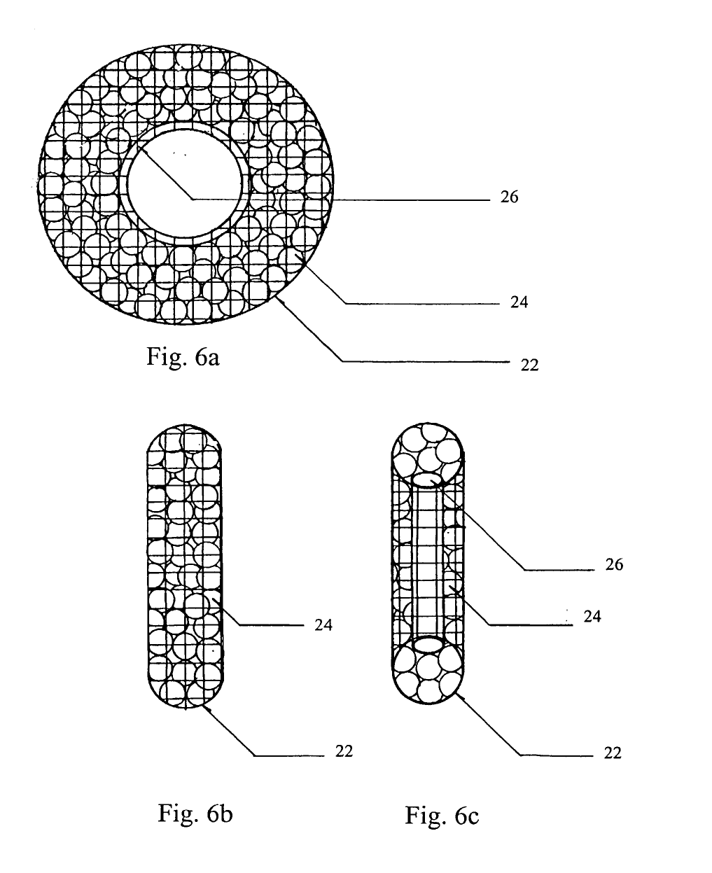

There are two presently preferred implementations of the present invention 20 with a conventional pneumatic tire T. Referring to FIGS. 6-8, shown is the present invention 20 in a combined configuration, where the elastic balls 24 and inner tube 26 of the present invention 20 are combined into one mesh sack 22. The combined configuration is assembled in the following manner: First, a plurality of elastic balls 24 is placed in the radially outward portion of a mesh sack 22 of appropriate size. The size of the mesh sack 22 and the number of elastic balls 24 are selected to fill the radially outward portion of the pneumatic volume of the tire T, which is determined by the tire diameter, tire width and tire aspect ratio. The elastic balls 24 should preferably occupy approximately 50% to 80% of the total pneumatic volume of the tire T when in the unpressurized state.

Second, an inner tube 16 with an inner diameter approximately equal to the outer diameter of the wheel W (and with an outer diameter less than the inner diameter of the tire T) is provided. The width of the inner tube 26 will be less than the width of the wheel W and tire T. The inner tube 26 is placed in the radially inward portion of the mesh sack 22 with the elastic balls 24 in the radially outward portion of the mesh sack 22. The inner tube 26 should preferably occupy the remaining space within the mesh sack 22 radially inward of the elastic balls 24, so that the inner tube 26 together with the elastic balls 24 occupy 100% of the mesh sack 22. The inner tube 26 also provides secondary protection in the event of a tire puncture. In the unlikely event that all elastic balls 24 are punctured, the tire T will still be inflated by the inner tube 26.

Third, a protective liner 28 having a length approximately equal to the exterior circumference of the wheel W and a width greater than or equal to the width of the inner tube 26 is provided between the wheel W and the mesh sack 22. The protective liner 28 should preferably extend to the sides of the wheel W so that the protective liner 28 completely shields the mesh sack 22 from the wheel W. The placement of the protective liner 28 in such fashion should prevent contact between the inner tube 26 and any metal part of the wheel W, as well as protect against puncture from any tools used (not shown) to install or remove the tire T from the wheel W. The protective liner 28 is preferably placed on the exterior of the radially inward portion of the mesh sack 22 so that the valve stem 30 of the inner tube 26 can pass through the protective liner 28 to mate with the valve hole (not shown) in the wheel W.

Fourth, the combined configuration is placed in the pneumatic tire T so that the elastic balls 24 are interposed between the inner tube 26 and the radially outward portion of the interior circumferential surface of the tire T and enclosed as shown. The inner tube 26 is then inflated in the conventional manner to a specified pressure. As the inner tube 26 is inflated, it will expand, compressing the elastic balls 24 within the mesh sack 22 within the space between the inner tube 26 and the interior circumferential surface of the tire T. By the time the inner tube 26 is pressurized to its specified pressure, the expansion of the inner tube 26 will cause the inner tube 26 and elastic balls 24 to completely fill the space, under pressure, between the tire T, wheel W, elastic balls 24 and inner tube 26. Because the inner tube 26 is within the mesh sack 22, the elastic balls 24 surround and press against the interior of the tire T, along the radially outward tread portion of the tire T, as well as the sidewalls of the tire T. The elastic balls 24 thus provide puncture resistance for the inner tube 26 from three directions (from the tread portion and both sidewalls of the tire T). This protection is particularly necessary when the tire T is subjected to possible puncture hazards in certain environments such as off-road or unpaved conditions with large divots or holes.

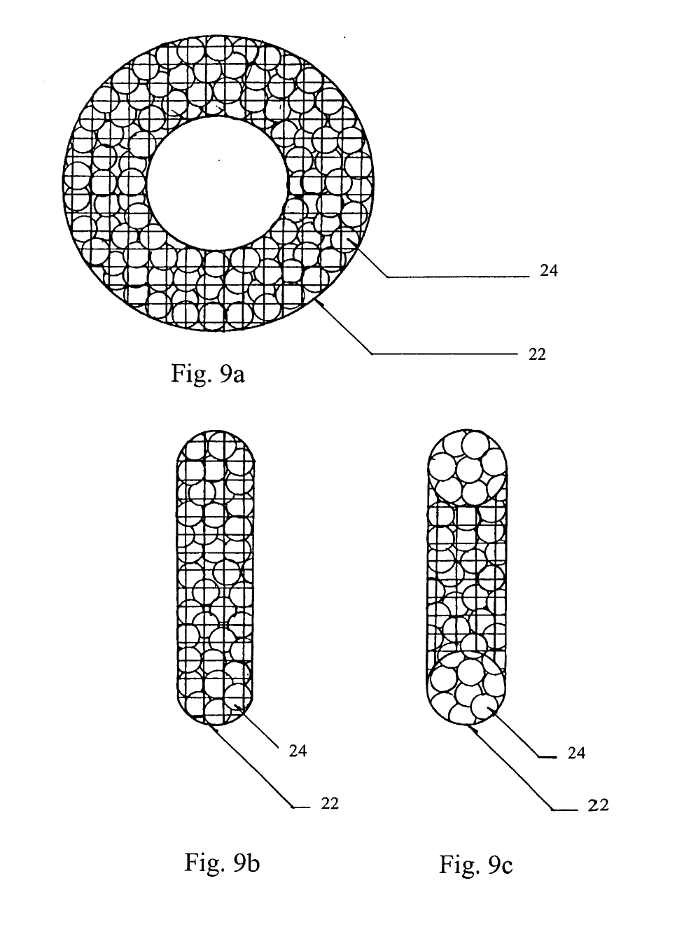

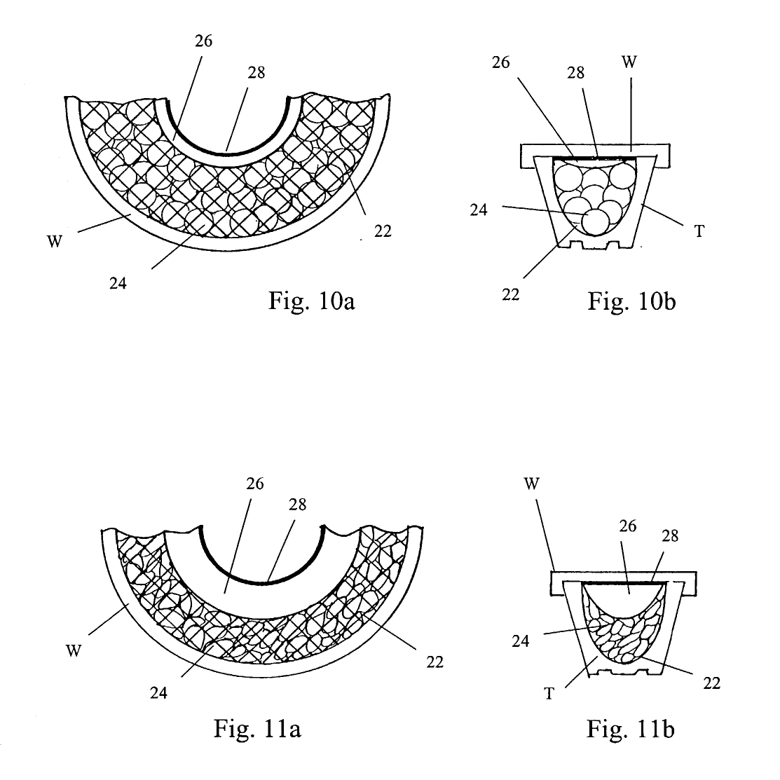

Referring to FIGS. 9-11, shown is a separated configuration, where the present invention 20 is used in a specific combination of the four components. First, a plurality of elastic balls 24 is placed in the radially outward portion of a mesh sack 22 of appropriate size. The size of the mesh sack 22 and the number of elastic balls 24 are selected to fill the radially outward portion of the pneumatic volume of the tire T, which is determined by the tire diameter, tire width and tire aspect ratio. The elastic balls 24 should preferably completely fill the mesh sack 22. The elastic balls 24 should preferably occupy approximately 50% to 80% of the total pneumatic volume of the tire T when in the unpressurized state.

Second, an inner tube 26 with an inner diameter approximately equal to the outer diameter of the wheel W (and an outer diameter less than the inner diameter of the tire T) is provided. The width of the inner tube 26 will be less than the width of the wheel W and tire T. The inner tube 26 is placed within radially inward portion of the tire T, on the exterior of the radially inward portion of the mesh sack 22. This configuration allows flexibility in the combinations possible using the mesh sack 22 with elastic balls 24 and the inner tube 26 based on performance or customer needs and desires.

Third, a protective liner 28 having a length approximately equal to the exterior circumference of the wheel W and a width greater or equal to the width of the inner tube is provided. The protective liner 28 should preferably extend to the sides of the wheel W so that the protective liner 28 completely shields the inner tube 26 and mesh sack 22 from the wheel W. The placement of the protective liner 28 between the inner tube 26 should prevent contact between the inner tube 26 and any metal part of the wheel W, as well as protect against puncture from any tools used (not shown) to install or remove the tire T from the wheel W. The protective liner 28 is preferably placed on the exterior of the radially inward portion of the mesh sack 22 so that the valve stem 30 of the inner tube 26 can pass through the protective liner 28 to mate with the valve hole (not shown) in the wheel W.

Fourth, the separated configuration is placed in the pneumatic tire T so that the elastic balls 24 within the mesh sack 22 are interposed between the inner tube 26 and the radially outward portion of the interior circumferential surface of the tire T and enclosed as shown. The inner tube 26 is then inflated in the conventional manner to a specified pressure. As the inner tube 26 is pressurized, it will expand, compressing the elastic balls 24 and the mesh sack 22 within the space between the inner tube 26 and the interior circumferential surface of the tire T. By the time the inner tube 26 is pressurized to its specified pressure, the expansion of the inner tube 26 will cause the inner tube 26 and elastic balls 24 to completely fill the space, under pressure, between the tire T, wheel W, elastic balls 24 and inner tube 26. The separated configuration provides the customer with a greater comfort in ride since the separated inner tube 26 will act as a cushioning device; however, the protection from punctures from the radially outward portions of the sidewall of the tire will be slightly compromised. The separated configuration will still maintain the tread-side and lower sidewall puncture protection. Although the separated configuration does not provide as much puncture resistance coverage as the combined configuration, the separated configuration allows more flexibility, and may be more desirable to certain customers, especially those customers seeking smoother rides with tires that also provides puncture resistance.

Most standard pneumatic tire pressures range from 28 psi (pounds per squared inch) for passenger automobiles to 60 psi for trucks and vans to 110 psi for motorcycles to 150+ psi for bicycles. With a wide range of pressures to consider, it is more practical to assign an inner tube to elastic ball pressure ratio rather than an absolute constant pressure for the inner tube and elastic balls.

The inner tube 26, as the compressing component, will preferably have a higher pressure than the elastic balls 24. The pressure of the elastic balls 24 will be based on the specified application use, depending on the type of vehicle (i.e., the pressure of the elastic balls 24 for a passenger automobile will differ from the pressure of the elastic balls 24 for a commercial truck). The conventional observation is that the inner tube 26 should be at least in a ratio of 1.01:1.00 or at least 1% greater in pressure. However, the present invention 20 preferably incorporates a greater pressure difference or ratio, preferably 1.10+:1.00 or 10% greater, to create proper deformation. The use of this ratio allows coverage of a wide variety of tire diameters, ranging from small tires used for mopeds or power carts (usually 8-12 inches) to automobile tires (usually 20-30 inches), to truck or military vehicles (usually 25-50 inches) to heavy industrial vehicle tires (usually greater than 50 inches).

To compensate for these different pressures, the elastic balls 24 and inner tube 26 must be manufactured to maintain at least a safety factor of two for all engineering calculations. An alternative is to manufacture different inner tubes 26 and elastic balls 24 for differing pressures.

For both the combined configuration and the separated configuration, several variations in components can be used. First, multiple inner tubes can be used instead of a single inner tube. The single unit system allows ease of installation. Second, multiple mesh sacks can also be used. However, the use of multiple mesh sacks may potentially cause weaknesses when a particular mesh sack loses its integrity, because the adjacent mesh sacks restrict smooth deformation movements. Installation of multiple mesh sacks can also be a tedious process.

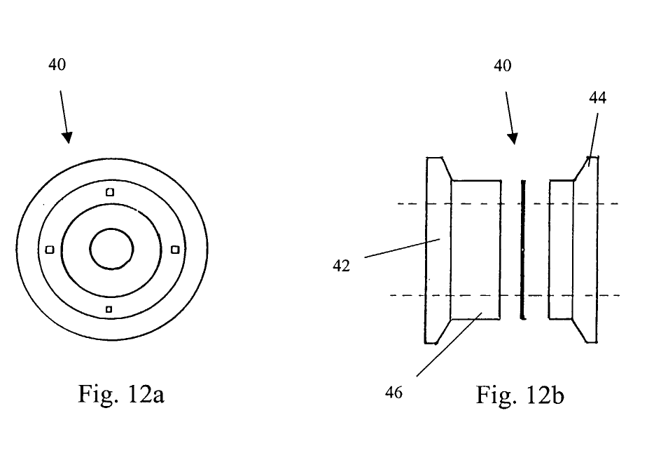

Referring to FIGS. 12a and 12b, an alternative embodiment of the present invention is shown. A two-piece modular wheel system 40 can be used with the present invention to simply and easily assemble the wheel, tire and the present invention. The larger of the wheel pieces 42 can be act as a base, then the tire T (not shown) and the invention 20 can be slid down the wheel shaft 46, then the smaller wheel piece 44 can be placed on top of the larger wheel piece 42 and locked in place.

The invention has been disclosed only with respect to the presently preferred embodiments described herein. However, those skilled in the art will appreciate that many alterations and modifications in the details of the invention can be made without departing from the scope and spirit of the invention. Accordingly, no limitations are to be implied or inferred in the invention, except as specifically and explicitly set forth in the attached claims.

### INDUSTRIAL APPLICABILITY

This invention can be used whenever it is desired to provide a run-flat tire device on conventional tires.

What is claimed is:

1. A device for a pneumatic tire having a tire diameter, a tire width, and a tread portion and two sidewall portions forming a substantially U-shaped cross-section which opens in a radially inward direction and defines a circumferential tire interior, said tire configured to be mounted on a wheel having a wheel diameter, a wheel circumference, and a wheel width, comprising:
an elastic mesh sack adapted to fit within a radially outward portion of said tire interior;
a plurality of hollow elastic balls placed within a radially outward portion of said mesh sack, wherein each of said elastic balls contain pressurized air having a ball air pressure;
a toroidal inflatable tube having a tube diameter between said tire diameter and said wheel diameter, said inflatable tube being placed within a radially inward portion of said mesh sack, wherein said inflatable tube can be inflated to a tube air pressure, whereby said inflated tube inflates to a size less than said tire interior;
an annular band having a band length equal to said wheel circumference and a band width between said tire width and said wheel width;
whereby said mesh sack containing said plurality of elastic balls and said inflatable tube can be placed within a radially outward portion of said tire interior, said annular band can be placed over the exterior of a radially inward portion of said mesh sack;
whereby said mesh sack containing said elastic balls and said inner tube is interposed between said annular band and said tread portion of said tire within said tire interior;
whereby said tire can be mounted on said wheel;
whereby said annular band is interposed between said wheel and said mesh sack within said tire interior;
whereby said annular band prevents contact between said wheel and said mesh sack; and
whereby said inflatable tube can be inflated to a tube air pressure causing said elastic balls to elastically deform and compress, under pressure, against said tread portion and said sidewall portions of said tire interior to fill a radially outward portion of said tire interior.

2. A device according to claim 1, wherein said tube air pressure of said inflatable tube is greater than said ball air pressure of each of said elastic balls.

3. A device according to claim 1, wherein said tube air pressure of said inflatable tube is at least 10% greater than said ball air pressure of each of said elastic balls.

4. A device according to any one of claims 1, 2, or 3, wherein said plurality of elastic balls occupy 50% to 80% of said tire interior.

5. A device for a pneumatic tire having a tire diameter, a tire width, and a tread portion and two sidewall portions forming a substantially U-shaped cross-section which opens in a radially inward direction and defines a circumferential tire interior, said tire configured to be mounted on a wheel having a wheel diameter, a wheel circumference, and a wheel width, comprising:
an elastic mesh sack adapted to fit within a radially outward portion of said tire interior;
a plurality of hollow elastic balls placed within a radially outward portion of said mesh sack, wherein each of said elastic balls contain pressurized air having a ball air pressure;
a toroidal inflatable tube having a tube diameter between said tire diameter and said wheel diameter, wherein said inflatable tube can be inflated to a tube air pressure, whereby said inflated tube inflates to a size less than said tire interior;
an annular band having a band length equal to said wheel circumference and a band width between said tire width and said wheel width;
whereby said mesh sack containing said plurality of elastic balls can be placed within a radially outward portion of said tire interior, said inflatable tube can be placed over a exterior portion of a radially inward portion of said mesh sack, said annular band can be placed over the exterior of a radially inward portion of said inflatable tube;
whereby said mesh sack containing said elastic balls is interposed between said inflatable tube and said tread portion of said tire within said tire interior;
whereby said inflatable tube is interposed between said annular band and said mesh sack within said tire interior;
whereby said annular band is interposed between said wheel and said inflatable tube within said tire interior;
whereby said tire can be mounted on said wheel;
whereby said annular band prevents contact between said wheel and said inflatable tube; and
whereby said inflatable tube can be inflated to a tube air pressure causing said elastic balls contained within said mesh sack to elastically deform and compress, under pressure, against said tread portion and said sidewall portions of said tire interior to fill a radially outward portion of said tire interior.

6. A device according to claim 5, wherein said tube air pressure of said inflatable tube is greater than said ball air pressure of each of said elastic balls.

7. A device according to claim 5, wherein said tube air pressure of said inflatable tube is at least 10% greater than said ball air pressure of each of said elastic balls.

8. A device according to any one of claims 5, 6, or 7, wherein said plurality of elastic balls occupy 50% to 80% of said cross section of said pneumatic tire.

9. A device for a pneumatic tire having a tire diameter, a tire width, and a tread portion and two sidewall portions forming a substantially U-shaped cross-section which opens in a radially inward direction and defines a circumferential tire interior, said tire configured to be mounted on a wheel having a wheel diameter, a wheel circumference, and wheel width, comprising:
a plurality of elastic mesh sacks, each of said mesh sacks adapted to fit within a radially outward portion of said tire interior;
a plurality of hollow elastic balls placed with a radially outward portion of each of said mesh sacks, wherein each of said elastic balls contains pressurized air having a ball air pressure;
a plurality of toroidal inflatable tubes, each having a tube diameter between said tire diameter and said wheel diameter, wherein one of said inflatable tubes can be placed in each of said mesh sacks, wherein each of said inflatable tubes can be inflated to a tube air pressure, whereby a totality of said inflatable tubes inflate to a size less than said tire interior;
an annular band having a band length equal to said wheel circumference and a band width between said tire width and said wheel width;
whereby each of said mesh sacks each containing said plurality of elastic balls and one of said inflatable tubes can be placed within a radially outward portion of said tire interior, said annular band can be placed over an exterior portion of a radially inward portion of each of said mesh sacks;
whereby each of said mesh sacks is interposed between said annular band and said tread portion of said tire within said tire interior;
whereby said annular band is interposed between said wheel and each of said mesh sacks within said tire interior;
whereby said tire can be mounted on said wheel;
whereby said annular band prevents contact between said wheel and each of said mesh sacks; and
whereby each of said inflatable tubes can be inflated to a tube air pressure causing said elastic balls to elastically deform and conform, under pressure, against said tread portion and said sidewall portions of said tire interior to fill a radially outward portion of said tire interior.

10. A device according to claim 9, wherein said tube air pressure of each of said inflatable tubes is greater than said ball air pressure of each of said elastic balls.

11. A device according to claim 9, wherein said tube air pressure of each of said inflatable tubes is at least 10% greater than said ball air pressure of each of said elastic balls.

12. A device according to any one of claims 9, 10, or 11, wherein totality of said plurality of elastic balls within said mesh sacks occupy 50% to 80% of said cross-section of said pneumatic tire.

13. A device for a pneumatic tire having a tire diameter, a tire width, and a tread portion and two sidewall portions forming a substantially U-shaped cross-section which opens in a radially inward direction and defines a circumferential tire interior, comprising:
a first wheel section being adapted to receive said pneumatic tire;
a second wheel section being adapted to be lockably removably affixed to said first wheel section;
wherein said first and second wheel sections can be lockably removably affixed to each other to form a wheel having a wheel diameter, a wheel circumference, and a wheel width;
an elastic mesh sack adapted to fit within a radially outward portion of said tire interior;
a plurality of hollow elastic balls placed within a radially outward portion of said mesh sack, wherein each of said elastic balls contain pressurized air having a ball air pressure;
a toroidal inflatable tube having a tube diameter between said tire diameter and said wheel diameter, said inflatable tube being placed within a radially inward portion of said mesh sack, wherein said inflatable tube can be inflated to a tube air pressure, whereby said inflated tube inflates to a size less than said tire interior;
an annular band having a band length equal to said wheel circumference and a band width between said tire width and said wheel width;
whereby said mesh sack containing said plurality of elastic balls and said inflatable tube can be placed within a radially outward portion of said tire interior, said annular band can be placed over the exterior of a radially inward portion of said mesh sack;
whereby said mesh sack containing said elastic balls and said inner tube is interposed between said annular band and said tread portion of said tire within said tire interior;
whereby said tire can be received by said first wheel section;
whereby said second wheel section is lockably removably affixed to said first wheel section to form said wheel;
whereby said annular band is interposed between said wheel and said mesh sack within said tire interior;
whereby said annular band prevents contact between said wheel and said mesh sack; and
whereby said inflatable tube can be inflated to a tube air pressure causing said elastic balls to elastically deform and compress, under pressure, against said tread portion and said sidewall portions of said tire interior to fill a radially outward portion of said tire interior.
